(19) United States
(12) Patent Application Publication
(10) Pub. No.: US 2009/0319413 A1
(43) Pub. Date: Dec. 24, 2009

(54) SYSTEM FOR DETECTING BANKING FRAUDS BY EXAMPLES

(75) Inventors: Malathi Kalyan, Bangalore (IN); Abhi Dattasharma, West Bengal (IN); Rajesh Vasudevan, Bangalore (IN); Santosh V. Yogindrappa, Bangalore (IN)

Correspondence Address: VENABLE LLP, P.O. BOX 34385, WASHINGTON, DC, 20043-9998, US

(73) Assignee: Saraansh Software Solutions Pvt. Ltd., Bangalore (IN)

(21) Appl. No.: 12/404,676

(22) Filed: Mar. 16, 2009

(30) Foreign Application Priority Data
Jun. 18, 2008 (IN) 1060/KOL/08

(51) Int. Cl. G06Q 40/00; G06F 15/18

(52) U.S. Cl. 705/35; 706/16

(57) ABSTRACT

A system for detecting banking frauds in historical data and future transactions from a user supplied specimen set of fraudulent transactions, said specimen set of transactions defining one type of fraud identified by the user, said system comprises: means (301) to accept at least one set of banking transactions from the user and means to accept a type of fraud associated with each said set of transactions from the user (FIG. 3, Step 1); means (302) to run a set of atomic clue detectors on each said transaction for each said specimen (FIG. 3, Step 2); means (303) to store the output of said clue detectors for each said transactions for each said specimen fraudulent transactions (FIG. 3, Step 3); means (303) to compare the output of each said clue detector with a pre-defined threshold (FIG. 3, Step 3); means (304, 305) to assign weight to each said clue detector (FIG. 3, Step 4 and 5); means (306) to combine the clue detectors and their said weights into one fraud scenario (FIG. 3, Step 6); and means (407, 408, 409) to apply said fraud scenario on an archive of transactions or online transactions for detecting possible fraud of the said type (FIG. 4, Step 7, 8, 9).

### FIELD OF INVENTION

The present invention relates to a system for detecting banking frauds. More particularly, the present invention relates to a system for analyzing banking transaction data and finding similar fraud examples given one or several user defined specimen frauds.

### PRIOR ART CITATIONS

Document WO 2006/085293, by Paul Kerley et at, discloses a transaction data processing system.

U.S. patent application Ser. No. 11/148,472 by Mitchell F Berk et al provides a runtime thresholds for behaviour detection.

U.S. patent application Ser. No. 11/252,696 by Clark R Abrahams et al provides a systems and methods for analyzing disparate treatment in financial transactions.

U.S. patent application Ser. No. 11/402,287 by Robert Welsh et at provides an integrated fraud management systems and methods.

U.S. Pat. No. 7,089,592 B2 by Akli Adjaoute provides a systems and methods for dynamic detection and prevention of electronic fraud.

U.S. Pat. No. 7,296,734 B2 by Robert K Pliha provides a systems and methods for scoring bank customers direct deposit account transaction activity to match financial behaviour to specific acquisition, performance and risk events defined by the bank using a decision tree and stochastic process.

In the known systems the problem of transaction fraud detection has been looked at from a global perspective. First, historical transactions are analyzed using stochastic, statistical or data mining methods to determine a model and then this model was applied to new transactions in real time. Several existing techniques built the model based on anomaly detection or behaviour analysis of user's pattern, and some have used a hybrid technology. Behaviour pattern has been used especially strongly for finding creditworthiness of a customer. However, all of these techniques invariably needed a set of previous transactions spanning over a sufficiently long time as a historical data, this data then acted as the critical part of the model builder. No existing technique works with user feedback to detect transaction fraud. This is, no existing technique can accept only a user specified set of fraudulent transactions and build a 10 model only from that. Thus, learning by examples is not tackled in prior art.

### SUMMARY OF THE INVENTION

The main object of the present invention is to provide a system for detecting banking frauds by mechanizing the discovery of similar instances of fraud with machine learning techniques.

This invention deals with an innovative system to detect frauds in banking transactions based on examples shown by user. The user points out a set of transactions in a transaction database as a specimen fraud. The system now analyzes this set of transactions, determines the important parameters of the transactions and assigns a set of clue detectors and their relative weights to define a “scenario” for this set. Once done, this scenario is then applied over the entire database of transactions to find all instances of similar frauds. This enables the user to find out hitherto unknown or missed fraudulent cases and help to audit the transactions 10 properly. Human ingenuity can find the first instance of new frauds. However, mechanizing the discovery of the similar instances is best done with machine learning techniques based on pattern recognition ideas. Additional digital forensics efforts required will be minimal, and no sophisticated hardware is needed.

In a preferred embodiment of the present invention it provides a system for detecting banking frauds in historical data and future transactions from a user supplied specimen set of fraudulent transactions, said specimen set of transactions defining one type of fraud identified by the user, said system comprises: means to accept at least one set of banking transactions from the user and means to accept a type of fraud associated with each said set of transactions from the user; means to run a set of atomic clue detectors on each said transaction for each said specimen; means to store the output of said clue detectors for each said transactions for each said specimen fraudulent transactions; means to compare the output of each said clue detector with a pre-defined threshold; means to assign weight to each said clue detector; means to combine the clue detectors and their said weights into one fraud scenario; and means to apply said fraud 10 scenario on an archive of transactions or online transactions for detecting possible fraud of the said type.

### BRIEF DESCRIPTION OF THE ACCOMPANYING DRAWINGS

The invention can now be described in detail with the help of the figures of the accompanying drawings in which

FIG. 1 is a block diagram of the system.

FIG. 2 is a block diagram showing a scenario and the clue detectors.

FIG. 3 is a flow diagram of the system where important parameters of an example fraud are extracted.

FIG. 4 is a flow diagram of the system where the determined set of parameters is used to find similar instances of fraud.

FIG. 5 is a diagram of the system for detecting banking frauds from user specified examples.

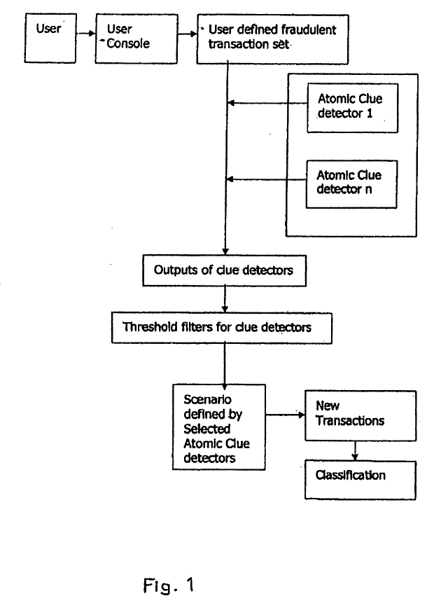

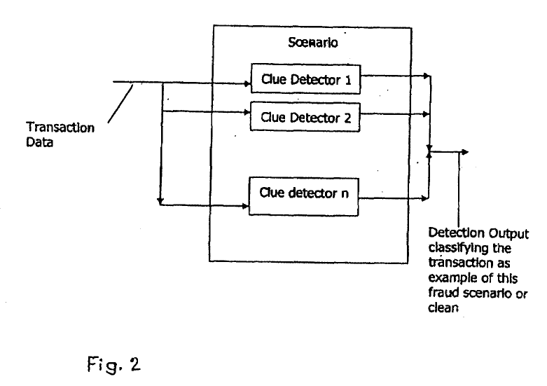

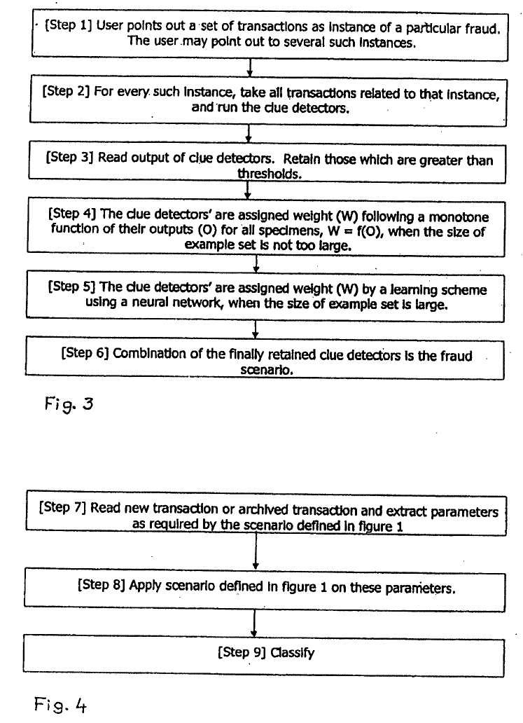

### DETAILED DESCRIPTION

In banking industry, chances of fraud taking place during a transaction are an omnipresent threat, and this can be quite serious in nature. This can not only harm a customer, but can damage a bank's reputation seriously. Therefore, it is necessary for a bank to have a fraud detection system in place.

Unfortunately, having a fraud detection system is not enough. Usually, any electronic system for fraud detection is not perfect, and fails to recognize certain frauds, especially the new and clever ones. Rectifying the software continuously to take into account such novel cases can be time and money wasting, and a bank cannot always afford to have that.

The present invention is a system that tackles the problem in a different way. In this system, the user simply points out a set of transactions which comprises a fraudulent case. The user is permitted to show more than one such case. That is, human intelligence is used by the system to tell it what may be a fraud. The system then picks up the transactions and analyzes the context and patterns hidden in those transactions. In the process, it extracts those parameters which seem to be most important for this particular case, and it creates a fraud scenario on its own. The parameters and their relative importance are then set up as a clue detector combination, which can then be used on any transaction to detect similar frauds.

The fundamentally new aspect of this invention is the following. All the existing techniques for detection of fraud provide a pre-defined set of clue detectors and a set of scenarios, and any transaction is mapped to this existing set. An intuitive outline is as follows:

Item 1: Build a set of atomic clue detectors, each one capable of defining one particular pre-defined transaction clue. For example, whether the debit value is more than the user's most commonly used debit values can be an atomic clue detector. A sample set of atomic clues are given below:
Credit pattern of the user
Debit pattern of the user
Usual transaction time of the user
User transaction channel of user
Usual transaction place of the user
If the transaction contains too low values
If user's account was dormant
If the user requested a change of address
If the transaction contains sharp bursts

Item 2: Build a set of fraud scenarios, each scenario is a depiction of a particular pre-defined fraud pattern. For example, a sudden burst of unusually high debits on successive days can be one fraud scenario.

Item 3: For each such scenario, define a set of clue detectors with their relative weights such that the clue detectors send back a heavy score when that fraud scenario occurs. For example, the scenario as above can use the clue detector “Debit pattern” of item 1 with high weight.

Item 4: For every new transaction, run each of these fraud scenarios, and report a fraud if the score is sufficiently high.

In the present invention, the above list is augmented with a very powerful new item:

Item 5: For any fraud instance found by a human moderator, ask the system to build automatically a fraud scenario depicting this fraud, and automatically set up clue detectors so that such frauds can now be automatically found.

The fraud detection will now be described by examples system in steps.

The first steps of the process are illustrated in FIG. 3. These are described below.

Step 0: First, the user marks a set of transactions as one instance of a fraud. If possible, the user marks several such sets as multiple examples.

Step 1: For every one of those transactions, all the atomic clue detectors are run.

Step 2: The output of each clue detector is taken, and the values are sorted.

Step 3: The clue detectors which return values greater than pre-defined threshold are retained for the final set.

Steps 4 and 5: A set of weight for the clue detectors are found using a functional mapping. The set of clue detectors which return values greater than pre-defined threshold for every specimen of fraud are given the highest weight; other clue detectors which were retained are given lower eight. The weight monotonically increase as the clue detectors' outputs increase. When the user gives a sufficiently large set of examples, the mapping is found using a learning scheme, namely, a backpropagation neural network.

Step 6: A combination of the final parameters is stored as a scenario for detecting the particular example fraud.

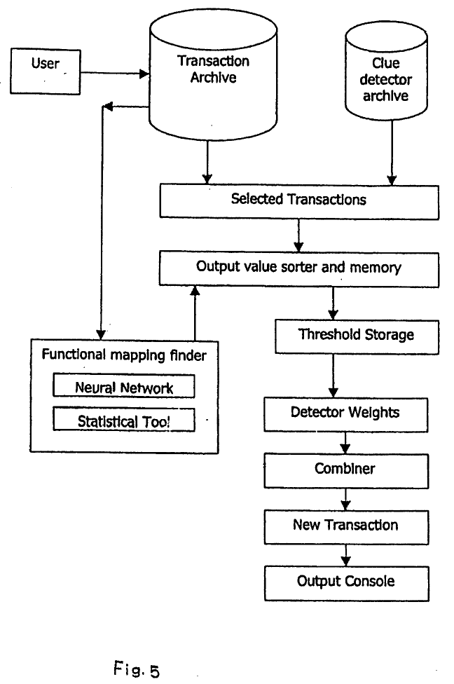

The aforementioned scenario is now used for detecting any suspicious outgoing e-mail. The steps are as follows, shown in FIG. 4.

Step 7: For every new transaction, said set of parameters as obtained in step 5 are extracted.

Step 8: The scenario as obtained in step 5 are run on this set of parameters.

Step 9: Depending on the score, a classification is given to the transaction if the said output crosses a pre-defined threshold or fails below a pre-defined threshold, respectively.

In the present invention for determination of the outputs of the atomic clue detectors for each said specimen fraudulent case, the system comprises: means for accepting a list of atomic clue detectors (FIG. 3, step 2); means for accepting the set of transactions for every said specimen fraudulent case (FIG. 3 step 1); means for running every atomic clue detector on each said transaction (FIG. 3 step 2); and means for storing the output of each said atomic clue detector on each said transaction of each said specimen fraudulent case (FIG. 3 step 3).

For determination of the outputs of the system a set of clue detectors for the final scenario, comprises: means for accepting a set of threshold values for the aforementioned set of atomic clue detectors (FIG. 3, step 3); means for comparing the output of each of said atomic clue detectors to the threshold for the corresponding atomic clue detector (FIG. 3 step 3); and means for retaining those clue detectors for which the output exceeds the said threshold.

For determining a set of weights for the set of clue detectors, the system comprises: means for designing a functional mapping f, said functional mapping accepting the output values of the clue detectors for all specimen fraudulent cases as inputs and returning a real value as output (FIG. 2 step 4); means for designing a neural network based learning scheme to generate a functional mapping f, the said functional mapping accepting the output values of the clue detectors for all specimen fraudulent cases as inputs and returning a real value as output; means for supplying the outputs of said clue detectors to said function (FIG. 3 steps 4 and 5); and means for storing the outputs of said function as weights corresponding to said clue detectors.

In the present invention a combination of the final parameters from the clue detectors is stored for detecting a fraud scenario. For using said fraud scenario to detect frauds similar to the specimen fraud shown by the user from archived data or from new transactions, the system further comprises: means for scanning old transactions from archived transaction data (FIG. 4 step 7); means for scanning new transactions (FIG. 4 step 7); means for applying said fraud scenario on archived transaction data (FIG. 4, step 8); means for applying the aforementioned fraud scenario on new transaction data (step 8); and means for classifying a set of transactions as fraud depending on a score obtained by application of the said fraud scenario [step 9].

1. A system for detecting banking frauds in historical data and future transactions from a user supplied specimen set of fraudulent transactions, said specimen set of transactions defining one type of fraud identified by the user, said system comprises:
means (301) to accept at least one set of banking transactions from the user and means to accept a type of fraud associated with each said set of transactions from the user (FIG. 3, Step 1);
means (302) to run a set of atomic clue detectors on each said transaction for each said specimen (FIG. 3, Step 2);
means (303) to store the output of said clue detectors for each said transactions for each said specimen fraudulent transactions (FIG. 3, Step 3);
means (303) to compare the output of each said clue detector with a pre-defined threshold (FIG. 3, Step 3);
means (304, 305) to assign weight to each said clue detector (FIG. 3, Step 4 and 5);
means (306) to combine the clue detectors and their said weights into one fraud scenario (FIG. 3, Step 6); and
means (407, 408, 409) to apply said fraud scenario on an archive of transactions or online transactions for detecting possible fraud of the said type (FIG. 4, Step 7, 8, 9).

2. A system according to claim 1 for determining the outputs of the atomic clue detectors for each said specimen fraudulent case, which further comprises:
means (301) for accepting a list of atomic clue detectors (FIG. 3, Step 1);
means (301) for accepting the set of transactions for every said specimen fraudulent case (FIG. 3, Step 1);
means (302) for running every atomic clue detector on each said transaction (FIG. 3, Step 2); and
means (303) for storing the output of each said atomic clue detector on each said transaction of each said specimen fraudulent case (FIG. 3, Step 3).

3. A system according to claim 1 for determining a set of clue detectors for the final scenario, which further comprises:
means (303) for accepting a set of threshold values for said set of atomic clue detectors (FIG. 3, Step 3);
means (303) for comparing the output of each of said atomic clue detectors to the threshold for the corresponding atomic clue detector (FIG. 3, Step 3); and
means (303) for retaining those clue detectors for which the output exceeds the said threshold (FIG. 3, Step 3).

4. A system according to claim 3 for determining a set of weights for said set of clue detectors, which further comprises:
means (304) for designing a functional mapping f, the said functional mapping accepting the output values of the clue detectors for all specimen fraudulent cases as inputs and returning a real value as output (FIG. 3, Step 4);
means (305) for designing a neural network based learning scheme to generate a functional mapping f, the said functional mapping accepting the output values of the clue detectors for all specimen fraudulent cases as inputs and returning a real value as output (FIG. 3, Step 5);
means (304, 305) for supplying the outputs of the aforementioned clue detectors to the said function (FIG. 3, Step 4 and 5); and
means (304, 305) for storing the outputs of the said function as weights corresponding to the said clue detectors (FIG. 3, Step 4 and 5).

5. A system (306) according to claim 5 for combining said clue detectors into a fraud scenario (FIG. 3, Step 6).

6. A system according to claim 1 for using the said fraud scenario to detect frauds similar to the specimen fraud shown by the user from archived data or from new transactions, which further comprises:
means (407) for scanning old transactions from archived transaction data (FIG. 4, Step 7);
means (407) for scanning new transactions (FIG. 4, Step 7);
means (408) for applying the aforementioned fraud scenario on archived transaction data (FIG. 4, Step 8);
means (408) for applying the aforementioned fraud scenario on new transaction data (FIG. 4, Step 8); and
means (409) for classifying a set of transactions as fraud depending on a score obtained by application of the said fraud scenario (FIG. 4, Step 9).
